(19) United States
(12) Patent Application Publication
(10) Pub. No.: US 2026/0118143 A1
(43) Pub. Date: Apr. 30, 2026

(54) TECHNIQUES FOR DETERMINING COMPENSATION PARAMETERS FOR A FIBER SENSOR

(71) Applicant: INTUITIVE SURGICAL OPERATIONS, INC., Sunnyvale, CA (US)

(72) Inventor: Patrick Roye, Christiansburg, VA (US)

(21) Appl. No.: 19/371,417

(22) Filed: Oct. 28, 2025

Related U.S. Application Data
(60) Provisional application No. 63/713,393, filed on Oct. 29, 2024.

(51) Int. Cl. G01D 5/353; G01K 11/32

(52) U.S. Cl. CPC G01D 5/35335; G01K 11/32

(57) ABSTRACT

Techniques for determining compensation parameters for a fiber sensor are disclosed herein. An example method includes detecting interferometric pattern data spanning an affected region of the fiber sensor when the fiber sensor is experiencing temperature transitions over the affected region. The example method further includes determining an optical path length parameter and a relative group index parameter that compensate for variations between a target optical configuration of the fiber sensor cores and an actual optical configuration of the fiber sensor cores.

### CROSS-REFERENCE TO RELATED APPLICATION

This application claims priority to U.S. Provisional Patent Application No. 63/713,393, entitled “Techniques for Determining Compensation Parameters for a Fiber Sensor,” filed on Oct. 29, 2024, the disclosure of which is hereby incorporated herein by reference.

### TECHNICAL FIELD

The present disclosure generally relates to fiber sensor calibration techniques, and more particularly, to determining compensation parameters for a fiber sensor having multiple cores based on interferometric pattern data detected when the fiber sensor is experiencing temperature transitions over an affected region.

### BACKGROUND

Calibrating optical fiber sensors with multiple cores, particularly those designed for shape sensing applications, is a significant challenge. Manufacturing processes are generally incapable of producing an ideal fiber structure that positions the fiber sensor cores exactly as specified by the original fiber design and produces cores with identical physical properties. Consequently, variations in core location, length, and index of refraction are commonly observed in actual fiber structures.

These sensors, often comprising multiple cores within a single fiber, or sometimes comprising a bundle of single core fibers, rely on precise core alignment to determine the fiber's shape based on the light propagation through each core. Certain calibration techniques focus on mechanical manipulations that induce strain differentials. However, these techniques often involve complex, time-consuming procedures and require specific materials and environmental conditions that can decrease their applicability and robustness.

Previous techniques for calibration can introduce non-linearities and inaccuracies, particularly when considering the fiber sensor's behavior under different environmental conditions (e.g., thermal expansion) or stress levels. For example, applications such as medical diagnostics can require significant precision to accomplish each task while subjecting the fiber sensors to varying temperatures and/or strains within the human body.

### SUMMARY

The following presents a simplified summary of various examples described herein and is not intended to identify key or critical elements or to delineate the scope of the claims.

In some aspects, the techniques described herein relate to a method of determining compensation parameters for a fiber sensor including a first core and a second core, the method including: detecting, with an interferometric detection circuitry when the fiber sensor is experiencing temperature transitions over an affected region, interferometric pattern data spanning at least the affected region for each core of the first core and the second core, the affected region extending at least from a first temperature transition region to a second temperature transition region; determining, with a data processing circuitry and based on the interferometric pattern data, (i) an optical path length parameter and (ii) a relative group index parameter, wherein the optical path length parameter and the relative group index parameter compensate for variations between a target optical configuration of the first core and the second core and an actual optical configuration of the first core and the second core; and storing the optical path length parameter and the relative group index parameter in a memory.

In some aspects, the techniques described herein relate to an apparatus for determining compensation parameters for a fiber sensor including a first core and a second core, the apparatus including: interferometric detection circuitry configured to detect, when the fiber sensor is experiencing temperature transitions over an affected region, interferometric pattern data spanning at least the affected region for each core of the first core and the second core, the affected region extending at least from a first temperature transition region to a second temperature transition region; and data processing circuitry configured to determine, based on the interferometric pattern data, (i) an optical path length parameter and (ii) a relative group index parameter, wherein the optical path length parameter and the relative group index parameter compensate for variations between a target optical configuration of the first core and the second core and an actual optical configuration of the first core and the second core; and store the optical path length parameter and the relative group index parameter in a memory.

In some aspects, the techniques described herein relate to a non-transitory computer-readable medium storing instructions for determining compensation parameters for a fiber sensor that, when executed, cause one or more processors of a control system to perform any of the methods described herein.

### BRIEF DESCRIPTION OF THE DRAWINGS

FIG. 1 depicts an end view of an example fiber sensor configuration including multiple fiber cores, in accordance with various embodiments described herein.

FIG. 2 is a schematic diagram for an example fiber sensor heating/cooling calibration apparatus for creating temperature transition regions within a fiber sensor, in accordance with various embodiments described herein.

FIG. 3A is a top-down perspective view of an example heating or cooling apparatus used to create temperature transitions over an affected region of a fiber sensor, in accordance with various embodiments described herein.

FIG. 3B is an oblique cross-sectional perspective view of the example heating or cooling apparatus of FIG. 3A, in accordance with various embodiments described herein.

FIG. 4 depicts an example calibration system in which various embodiments of the present disclosure may be implemented.

FIG. 5A is a plot of a temperature response of multiple sensor cores of a fiber sensor over an affected region of the fiber sensor that includes a temperature response differential between a first core and a second core, in accordance with various embodiments described herein.

FIG. 5B is a plot of a temperature response of multiple sensor cores of a fiber sensor over an affected region of the fiber sensor after application of an optical path length parameter and/or a relative group index parameter, in accordance with various embodiments described herein.

FIG. 5C is a plot indicating a twist value of a fiber sensor before and after optimizing parameters of a first core of the fiber sensor based on interferometric pattern data resulting from temperature transition regions over an affected region of the fiber sensor, in accordance with various embodiments described herein.

FIG. 6 depicts a flow diagram representing an example computer-implemented method for calibrating a fiber sensor, in accordance with various embodiments described herein.

FIG. 7 depicts a flow diagram representing another example computer-implemented method for determining compensation parameters based on interferometric pattern data resulting from temperature transitions over an affected region of a fiber sensor, in accordance with various embodiments described herein.

Examples of the present disclosure and their advantages are best understood by referring to the detailed description that follows. It should be appreciated that like reference numerals are used to identify like elements illustrated in one or more of the figures, wherein showings therein are for purposes of illustrating examples of the present disclosure and not for purposes of limiting the same.

### DETAILED DESCRIPTION

In the following description, specific details are set forth describing some examples consistent with the present disclosure. Numerous specific details are set forth in order to provide a thorough understanding of the examples. It will be apparent, however, to one skilled in the art that some examples may be practiced without some or all of these specific details. The specific examples disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one example may be incorporated into other examples unless specifically described otherwise or if the one or more features would make an example non-functional. In some instances, well known methods, procedures, components, and circuits have not been described in detail so as not to unnecessarily obscure aspects of the examples.

This disclosure describes various instruments and portions of instruments in terms of their state in three-dimensional space. The instruments may be any sort of instrument used to perform a procedure as described herein (e.g., a flexible instrument, a semi-rigid instrument, a rigid instrument, etc.). As used herein, the term “position” refers to the location of an object or a portion of an object in a three-dimensional space (e.g., three degrees of translational freedom along Cartesian x-, y-, and z-coordinates). As used herein, the term “orientation” refers to the rotational placement of an object or a portion of an object (e.g., one or more degrees of rotational freedom such as, roll, pitch, and yaw). As used herein, the term “pose” refers to the position of an object or a portion of an object in at least one degree of translational freedom and to the orientation of that object or portion of the object in at least one degree of rotational freedom (e.g., up to six total degrees of freedom). As used herein, the term “shape” refers to a set of poses, positions, and/or orientations measured along an object. As used herein, the term “distal” refers to a position that is closer to a procedural site and the term “proximal” refers to a position that is further from the procedural site. Accordingly, the distal portion or distal end of an instrument is closer to a procedural site than a proximal portion or proximal end of the instrument when the instrument is being used as designed to perform a procedure.

Given the complexity and precision required in modern fiber sensor technology, particularly for medical applications, the need for robust and efficient calibration methods is paramount. The present techniques introduce an improvement in the calibration of multi-core fiber sensors by, for example, reducing the reliance of fiber sensor calibration (e.g., outer cores to center core) on various physical properties of the fiber sensor. Certain techniques imposing mechanical strain to fully calibrate the fiber sensor require the fiber sensor to have a material composition that creates sufficient friction with the testing apparatus to hold varying strain levels on the fiber sensor instead of allowing the strain to equalize over the fiber sensor, which limits the set of available materials for fiber sensor composition. Further, many techniques require varying the fiber sensor strain wind, which significantly increases the complexity and time required to complete calibration.

As an example, certain techniques wind the fiber sensor around a cylinder to align outer cores of the fiber sensor. If the outer cores are helically-wound at a constant spin rate and are misaligned, then the fiber sensor will erroneously appear twisted during the winding, causing sinusoidal waveforms in the detected signals from the outer cores. Thus, these techniques enable alignment of the outer cores by adjusting phase parameters of the outer cores until such sinusoidal waveforms cancel out in the detected signals. The center core of these multi-core fiber sensors does not experience this sinusoidal behavior due to winding, as the center core is unaffected by twisting. These techniques attempt to account for this effect by oscillating/varying the winding speed to manufacture sinusoidal waveforms through more/less stress during the winding, but such oscillations can introduce amplitude or frequency variability in the detected signals from the center/outer cores.

The present techniques improve over these techniques by leveraging thermal calibration data to compensate for several of the variations that exist between/among cores of a multi-core fiber sensor. More specifically, the present techniques utilize temperature changes to create sharp transitions in the temperature profile of the fiber where differences in the thermal response between/among cores are readily observed. The present techniques analyze these thermal response differences to determine optical path length and relative group index parameters using one or more algorithmic solutions described herein. As a result, the present techniques simplify and expedite the calibration process at least by improving the center/outer core signal resolution, which enables more consistent alignment of the center core with the outer cores. The present techniques are therefore more accurate and less reliant on specific apparatus/fiber sensor materials or configurations than many typical techniques. Additionally, thermal calibrations are often performed for fiber sensors, such that in many instances the present techniques do not require additional equipment or significant additional time to achieve core calibration.

Further, the present disclosure includes specific features other than what is well-understood, routine, conventional activity in the field, or adding unconventional steps that demonstrate, in various embodiments, particular useful applications, e.g., detecting, with an interferometric detection circuitry when the fiber sensor is experiencing temperature transitions over an affected region, interferometric pattern data spanning at least the affected region for each core of the first core and the second core, the affected region extending at least from a first temperature transition region to a second temperature transition region; and/or determining, with a data processing circuitry and based on the interferometric pattern data, (i) an optical path length parameter and (ii) a relative group index parameter that compensate for variations between a target optical configuration of the first core and the second core and an actual optical configuration of the first core and the second core, among others.

Of course, it should be appreciated that the advantages and technical improvements described above and elsewhere herein are not the only advantages and/or technical improvements that may be realized as a result of the techniques described herein.

More generally, the present techniques may be part of a larger calibration process for multi-core fiber sensors, wherein multiple different calibration steps/actions are performed to align all of the cores and calibrate them for various environmental factors (e.g., bend, strain, twist, temperature). As mentioned, the specific techniques described herein may facilitate more accurate and efficient calibration and may also completely replace certain portions of more complex calibration processes.

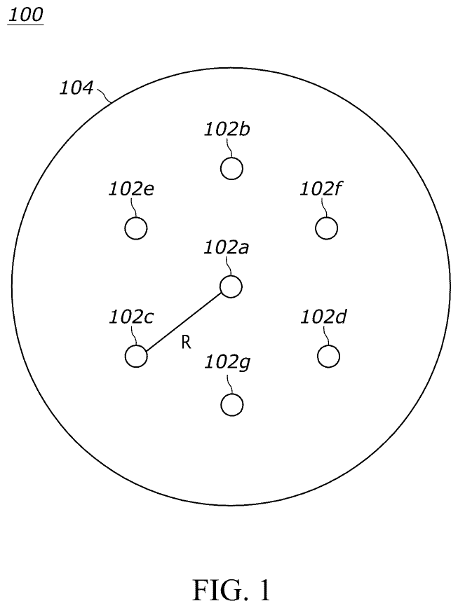

FIG. 1 depicts an end view of an example fiber sensor configuration 100 including multiple fiber cores 102a-g, in accordance with various embodiments described herein. Generally, the example fiber sensor configuration 100 is a cross-sectional view of a fiber sensor with seven fiber cores 102a-g encased in a cladding 104. The fiber cores 102a-g include a center core 102a and six outer cores 102b-g (also referenced herein as “peripheral cores”) that are generally positioned at a radius R from the center core 102a. While illustrated as seven fiber cores, it should be appreciated that other numbers of cores are also possible, such as four cores, six cores, etc. In some embodiments, one or more of the outer cores 102b-g are not positioned at the radius R from the center core 102a, and instead are offset from the center core 102a by a second distance that is different from the radius R. Moreover, in certain embodiments, each fiber core 102a-g may be individually encased within a cladding.

FIG. 1 depicts an embodiment where the multiple fiber cores (e.g., cores 102a-g) are disposed within a same optical fiber. For example, the multiple fiber cores (e.g., cores 102a-g) are disposed within a same cladding (e.g., cladding 104). In an alternate embodiment, the multiple fiber cores (e.g., cores 102a-g) are each single-core fibers, such that a fiber sensor like that depicted in the example fiber sensor configuration 100 would comprise a bundle of single core fibers, with peripheral single core fibers disposed around a central core fiber.

While not depicted in FIG. 1, each of the outer cores 102b-g may be helically-wrapped (also referenced herein as “twisted” or “spun”) around the center core 102a. In certain embodiments, the outer cores 102b-g may not be twisted around the center core 102a. When the outer cores 102b-g are twisted around the center core 102a, any twist applied to the fiber sensor results in strain experienced by the outer cores 102b-g. Each outer core 102b-g is either elongated or compressed in response to the orientation of the twist relative to the direction of the outer core 102b-g wrapping around the center core 102a. The techniques described herein can account for these variations resulting from twist applied to the fiber sensor by, for example, determining linear fits of twist parameters determined based on interferometric pattern data detected when the fiber sensor experiences a temperature transition over an affected region.

The seven fiber cores 102a-g may each provide data that is used (independently or in groups) as part of the fiber sensor calibration process, as described herein. For example, the data measured from the center core 102a and three of the peripheral cores (e.g., cores 102b-d) may be used to calculate fiber sensor bend, axial strain, and/or twist. The data measured from additional cores (e.g., a fourth peripheral core such as core 102f, a fifth peripheral core such as 102e and sixth peripheral core such as core 102g) may be used for temperature calibration, other environmental calibration, reliability checks, additional bend, axial strain, and/or twist calculations, and the like. In certain embodiments, the systems described herein may not acquire/measure data from one or more of the cores, and instead leave them uninterrogated, use them to absorb light in cladding, reduce cross-talk, and the like. As a specific example, the data measured from a fourth peripheral core (e.g., core 102f) may be used for temperature compensation.

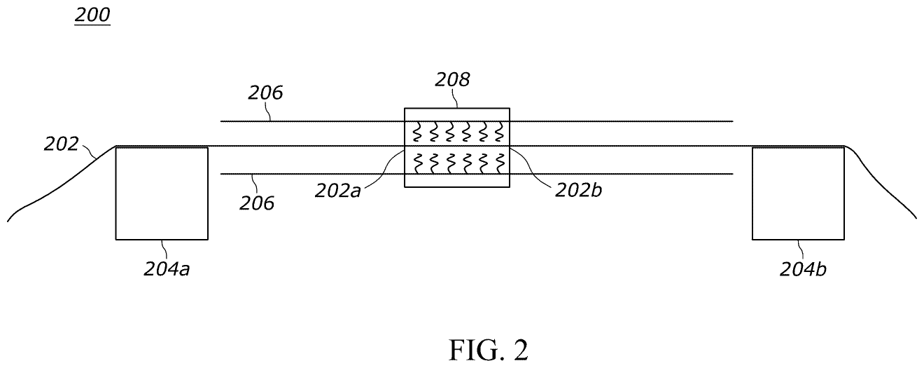

Regardless, the techniques of the present disclosure include applying heating and/or cooling to one or more sections of a fiber sensor generally configured similarly to the example fiber sensor configuration 100 using a heating/cooling apparatus. FIG. 2 is a schematic diagram for an example fiber sensor heating/cooling calibration apparatus 200 for creating temperature transition regions within a fiber sensor, in accordance with various embodiments described herein. The example fiber sensor heating/cooling calibration apparatus 200 includes a fiber sensor 202 stretched between two attachment points 204a, 204b and within a heating/cooling apparatus 206.

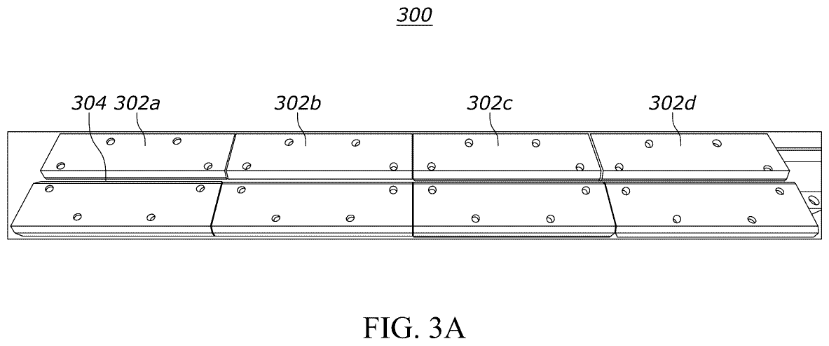

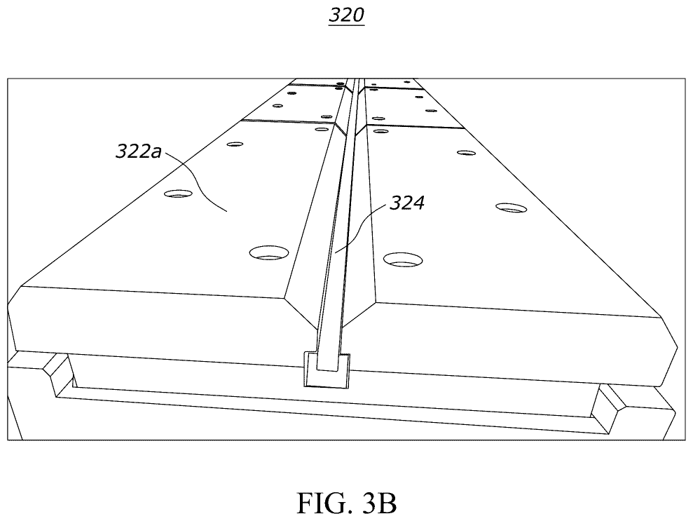

The heating/cooling apparatus 206 is generally configured to heat or cool sections of the fiber sensor 202, thereby creating sharp temperature transitions between the heated/cooled section(s) and the non-heated/cooled section(s) of the fiber sensor 202. The heating/cooling apparatus 206 illustrated in FIG. 2 applies heating or cooling to the fiber sensor 202 section within the region 208, causing it to be significantly hotter or colder than the remainder of the fiber sensor 202. In particular, the heating/cooling apparatus 206 creates a first temperature transition region 202a and a second temperature transition region 202b. These temperature transition regions 202a, 202b generally reference portions of the fiber sensor 202 within the region 208 that are near edges (e.g., left/right edges) of the region 208, where the temperature of the fiber sensor 202 transitions from the ambient temperature (e.g., of the fiber sensor 202 outside of the region 208) to the temperature caused by the heating/cooling applied by the heating/cooling apparatus 206. In certain embodiments, the heating/cooling apparatus 206 is a thermo-electric cooler/heater, as illustrated in FIGS. 3A and 3B.

As mentioned, the actual configuration (e.g., actual core location, length, index of refraction) of the fiber sensor 202 generally differs from the target optical configuration as a result of imperfect manufacturing processes. For example, spinning the outer cores around the center core (e.g., resulting in a helix shape) results in variable longer/shorter lengths of the outer cores without affecting the center core length, such that light reaches each core at a slightly different time because the path length for the light to reach each core is different. Additionally, each core often has a different transmission velocity due to small chemical variations in the composition of the materials (e.g., glass composite) for each core. These differences from a target optical configuration cause the cores to respond to tension, strain, bend, and temperature slightly differently from one another.

Thus, by creating these temperature transition regions 202a, 202b, signals (e.g., light) transmitted through the fiber sensor 202 will indicate these differences from the target optical configuration. In particular, the heating/cooling applied by the heating/cooling apparatus 206 alters the index of refraction of the fiber sensor 202, which each core may experience slightly differently (e.g., at different positions), as indicated by signals detected from the different cores at the temperature transition regions 202a, 202b.

FIG. 3A is a top-down perspective view 300 of an example heating or cooling apparatus used to create temperature transitions over an affected region of a fiber sensor, in accordance with various embodiments described herein. The example heating or cooling apparatus is a thermo-electric heater/cooler comprised of a set of individual heating/cooling devices 302a-d each configured to heat or cool specific portions of a fiber sensor. A fiber sensor is generally positioned in the channel 304 of the example heating or cooling apparatus, and one or more of the set of individual heating/cooling devices 302a-d may apply heating or cooling to the portion of the fiber sensor disposed within the channel 304 adjacent to the one or more individual heating/cooling devices.

For example, a fiber sensor may be disposed in the channel 304, and the control systems described herein may apply cooling to a portion of the fiber sensor disposed in the channel 304 adjacent to a second heating/cooling device 302b. The portion of the fiber sensor may then lower in temperature relative to the remaining portions of the fiber sensor (e.g., disposed in channel 304 adjacent to other heating/cooling devices 302a, 302c, 302d), which creates temperature transition regions within the fiber sensor near the edges of the second heating/cooling device 302b (e.g., adjacent to the heating/cooling devices 302a, 302c). When the portion of the fiber sensor is cooled, the detection circuitry described herein may detect interferometric pattern data of the fiber sensor cores within the cooled portion to determine compensation parameters (e.g., optical path length, relative group index).

In certain embodiments, the fiber sensor may be heated/cooled by each of the set of heating/cooling devices 302a-302d (e.g., one at a time) to detect interferometric pattern data at multiple locations of the fiber sensor.

FIG. 3B is an oblique cross-sectional perspective view 320 of the example heating or cooling apparatus of FIG. 3A, in accordance with various embodiments described herein. This oblique cross-sectional perspective view 320 shows the general configuration of an individual heating/cooling device 322a and the channel 324 for receiving the fiber sensor. In certain embodiments, the bottom surface of the channel 324 is comprised of copper segments that are heated/cooled by the individual heating/cooling devices comprising the example heating or cooling apparatus but may include any suitable materials or combinations thereof. For example, the individual heating/cooling device 322a may heat/cool the copper in the channel 324 that is physically disposed adjacent to the device 322a, which transfers the heat to the fiber sensor portion adjacent to the device 322a or acts as a heat sink for the fiber sensor portion to heat/cool the fiber sensor portion accordingly.

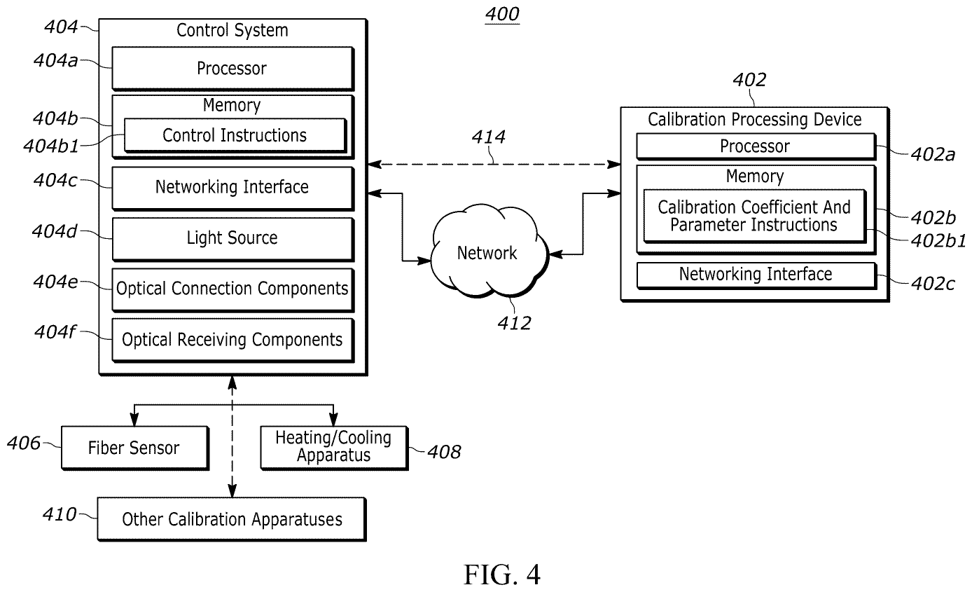

FIG. 4 depicts an example calibration system 400 in which various embodiments of the present disclosure may be implemented. Depending on the embodiment, the example calibration system 400 includes a calibration processing device 402 and a control system 404 that generally perform/control calibration processes for a fiber sensor 406 using a heating/cooling apparatus 408 and/or other calibration apparatuses 410. The example calibration system 400 detects/acquires data from the fiber sensor 406 during these calibration processes and uses this data to determine run-out corrections that adjust for physical curvature of the fiber sensor 406 (e.g., fiber sensor 406 is off-axis when laid straight), calibration coefficients to account for phase differences between individual cores in response to certain stimuli (e.g., strain, twist, temperature, bend), compensation parameters to align individual cores (e.g., center core to outer cores, outer core to outer core), and/or any related values or combinations thereof.

Of course, it should be appreciated that, while the various components of the example calibration system 400 (e.g., calibration processing device 402, other calibration apparatuses 410, etc.) are illustrated in FIG. 1 as single components, the example calibration system 400 may include multiple calibration processing devices 402, heating/cooling apparatuses 408, and/or other calibration apparatuses 410 that are simultaneously connected (e.g., via network 412) at any given time.

Each of the calibration processing device 402, the control system 404, the fiber sensor 406, the heating/cooling apparatus 408, and the other calibration apparatuses 410 may communicate (directly or indirectly) with the other devices (e.g., transmit data, instructions, etc.) across the network 412 or through physical communication links 414 (e.g., one or more wired and/or PANs or LANs). As an example, the control system 404 may control (e.g., via control instructions 404b1) a calibration process of the fiber sensor 406 by adjusting/controlling one or more parameters of the heating/cooling apparatus 408 while transmitting light from the light source 404d through the optical connection components 404e to one or more cores of the fiber sensor 406. The control system 404 receives data (e.g., reflected light signals) from the fiber sensor 406 indicating changes to the physical properties of the sensor 406 as a result of these temperature adjustments, and the system 404 may transmit this data to the calibration processing device 402 for analysis. The calibration processing device 402 executes the calibration coefficient and parameter instructions 402b1 to determine one or more coefficients (e.g., strain, temperature, twist, bend) and/or one or more parameters (e.g., optical path length, relative group index) based on the received data.

One or more components of the control system 404, such as the one or more processors 404a, the memory 404b, the control instructions 404b1, the light source 404d, the optical connection components 404e, and/or the optical receiving components 404f may collectively comprise “interferometric detection circuitry” configured to, for example, detect signals/data from the fiber sensor 406. For example, when executed by the one or more processors 404a, the control instructions 404b1 stored in the memory 404b may cause the light source 404d to emit light that is transmitted through the optical connection components 404e and into the respective cores of the fiber sensor 406 for calibration and/or other testing purposes. This incident light is transmitted and intermittently scattered back through the fiber sensor 406 cores into one or more of the optical receiving components 404f configured to receive the backscattered light and/or convert the signals into electrical signals and/or digital signals (e.g., interferometric pattern data) for processing at the calibration processing device 402. Thus, various components of the control system 404 may perform functions or portions of functions described herein as being performed by the interferometric detection circuitry.

Moreover, one or more components of the calibration processing device 402, such as the one or more processors 402a, the memory 402b, and/or the calibration coefficient and parameter instructions 402b 1 may collectively comprise “data processing circuitry” configured to, for example, determine calibration parameters, calibration coefficients, and/or store the parameters/coefficients in memory (e.g., memory 402b). For example, when executed by the one or more processors 402a, the calibration coefficient and parameter instructions 402b1 stored in the memory 402b may analyze the received interferometric pattern data from the control system 404 to determine an optical path length parameter and a relative group index parameter and/or to store these parameters in a memory (e.g., memory 402b, 404b). The memory 402b, 404b may generally be a non-transitory computer-readable medium, such as a hard drive, a solid-state drive (SSD), a file/database in a cloud location, and/or other suitable non-transitory storage medium or combinations thereof. Thus, various components of the calibration processing device 402 may perform functions or portions of functions described herein as being performed by the data processing circuitry.

The received data from a calibration process described herein, where the fiber sensor 406 experiences temperature transitions over an affected region (e.g., in FIGS. 2, 3A, and 3B), includes interferometric pattern data spanning at least the affected region of the fiber sensor 406. As an example, the center core (e.g., center core 102a) of the fiber sensor 406 may be unaligned with the outer cores (e.g., cores 102b-g), and as a result, may not experience the temperature event in the same manner (e.g., at the same location) as the outer cores, and the interferometric pattern data may indicate this difference. The calibration coefficient and parameter instructions 402b 1 analyze this interferometric pattern data to determine an optical path length parameter and a relative group index parameter that compensate for variations between a target optical configuration of a first core (e.g., center core) of the fiber sensor 406 and a second core (e.g., one or more outer cores) and an actual optical configuration of the first core and the second core.

The optical path length parameter generally accounts for differences in the optical path length light travels in each core by adjusting the effective starting point for the light in data received from each core, as necessary. The relative group index parameter accounts for differences in propagation speed in each core. With both of these parameters, the example calibration system 400 can achieve relative alignment of the fiber sensor 406 cores for which data was received. To determine these parameters, the calibration processing device 402 may perform one or more of several algorithmic strategies. The device 402 may utilize one or more of these algorithms to align the center core (e.g., center core 102a) with one or more of the outer cores (e.g., cores 102b-g), and in certain embodiments, may utilize one or more of the algorithms to align one or more outer cores with one or more of the other outer cores.

Generally, the device 402 may employ any of these algorithms in response to receiving interferometric pattern data from the fiber sensor 406 when the temperature transition region is created by heating or cooling the fiber sensor 406. In some embodiments, the device 402 may generate the optical path length parameter and the relative group index parameter using one or more composite values from both heating/cooling data sets. For example, the device 402 may compare the optical path length parameters, the relative group index parameters, and/or any other intermediate values (e.g., offsets, cross-correlations) obtained using interferometric pattern data from temperature transition regions representing the fiber sensor 406 being heated with analogous values obtained using interferometric pattern data from the same temperature transition regions representing the fiber sensor 406 being cooled to determine the final/ideal optical path length parameter and the relative group index parameter.

As an example algorithm, the device 402 determines twist parameters indicating deviations from the target optical configuration for a first core and a second core at both temperature transition regions (e.g., regions 202a, 202b), and determines offset values between the interferometric pattern data for the cores at the temperature transition regions based on a fit (e.g., linear fit) of the twist parameters in each region. The device 402 may further optimize these offset values by minimizing the residual error of the performed fit at the temperature transition regions. The device 402 also performs a subsequent fit (e.g., linear) using the two optimized offset values in conjunction with their respective locations within the fiber sensor 406 to determine the optical path length parameter and the relative group index parameter. In these embodiments, the optimized offsets may serve as the y-values in a linear fit and the physical locations within the fiber sensor 406 may serve as the x-values in a linear fit, such that the optical path length parameter is the y-offset of the fit and the relative group index parameter is the slope of the fit. In some examples, the first core is a center core (e.g., center core 102a) and the second core is an outer core (e.g., outer core 102b) spun around the center core.

In another example algorithm, the device 402 determines cross-correlations associated with the general shape of the fiber sensor 406 to determine the optical path length parameter and the relative group index parameter. Specifically, the device 402 determines cross-correlations between the phase of a first core and a second core at the temperature transition regions to determine the parameters. The device 402 may utilize these cross-correlations to determine a distance (e.g., x-axis) offset between the first and second core phase signals that minimizes the differences in their respective phase (e.g., y-axis) values. In this manner, the device 402 determines how much any individual core of two cores may need to be shifted so that the phase graphs/values of the two cores are maximally aligned. In some examples, the first core or the second core comprises a plurality of cores (e.g., the second core is multiple outer cores), and the cross-correlations are between a phase of the interferometric pattern data of the first core and an average phase of the interferometric pattern data of the plurality of cores at the temperature transition regions.

In still another example algorithm, the device 402 thresholds on points within the interferometric pattern data of the temperature transition regions and utilizes differentials in the data between a first core and a second core of the fiber sensor 406 to determine the optical path length parameter and the relative group index parameter. The device 402 determines a first relative phase offset between the interferometric pattern data of a first core and a second core at a first location in a first temperature transition region (e.g., region 202a) and a second relative phase offset between the interferometric pattern data of the first core and the second core at a second location in the second temperature transition region (e.g., region 202b). The device 402 then determines the optical path length parameter and the relative group index parameter based on the first relative phase offset and the second relative phase offset. In certain examples, the first core or the second core comprises a plurality of cores (e.g., the second core is multiple outer cores), and the relative phase offsets are between a phase of the interferometric pattern data of the first core and an average phase of the interferometric pattern data of the plurality of cores at the temperature transition regions.

In certain embodiments, the device 402 may also be utilized to perform a temperature calibration for the fiber sensors described herein. As part of this temperature calibration process, a heating or cooling apparatus (e.g., heating or cooling apparatus illustrated in FIGS. 3A and 3B) may apply different temperatures to the fiber sensor. The interferometric detection circuitry described herein may detect interferometric pattern data for respective sets of cores of the fiber sensors (e.g., a center core and one or more outer cores) while the heating or cooling apparatus is applying different temperatures to the fiber sensor. The data processing circuitry described herein may determine, based on the interferometric pattern data, temperature parameters that compensate for variations in the temperature response between the respective sets of cores, and the data processing circuitry may also store the temperature parameters in memory (e.g., memory 402b, 404b). In certain embodiments, the temperature calibration processes described herein can provide core-specific temperature coefficients. Further, in some embodiments, taking temperature measurements for the temperature calibration processes described herein may be performed before or after taking measurements for the compensation parameters described herein.

More generally, the calibration processing device 402 includes the one or more processors 402a, the memory 402b, and a networking interface 402c. The memory 402b stores executable instructions that are configured to, when executed by the one or more processors 402a, cause the one or more processors 402a to analyze data (e.g., interferometric pattern data) received at the calibration processing device 402 and output various values (e.g., optical path length parameter and the relative group index parameter, calibration coefficients). The calibration coefficient and parameter instructions 402b1 include such executable instructions, as well as other data. The memory 402b may also store additional data and/or databases. The calibration processing device 402 receives data from the control system 404 through a network 412 and/or through physical communication links 414 and processes the data in accordance with one or more sets of instructions stored in the memory 402b to output any of the values described herein.

It should be appreciated that the calibration processing device 402 can include one or multiple computing devices that are co-located or distributed. Moreover, in some embodiments, the calibration processing device 402 is located/stored in a remote location from the control system 404 (e.g., a cloud-based server). In these embodiments, the control system 404 accesses the calibration processing device 402 by transmitting data (e.g., interferometric pattern data) to the cloud-based server. The calibration processing device 402 analyzes the inputs (e.g., using calibration coefficient and parameter instructions), generates outputs (e.g., optical path length parameter and the relative group index parameter, calibration coefficients), and the cloud-based server returns these outputs to the control system 404.

The control system 404 includes the one or more processors 404a, the memory 404b, a networking interface 404c, a light source 404d, and one or more optical connection components 404e. The memory 404b stores executable instructions that are configured to, when executed by the one or more processors 404a, cause the one or more processors 404a to analyze data (e.g., calibration instructions) received at the control system 404 and output various values (e.g., control instructions). The control instructions 404b1 include such executable instructions, as well as other data. The memory 404b may also store additional data and/or databases. The control system 404 receives data from the calibration processing device 402 and/or other external sources (e.g., a calibration workstation—not shown) through the network 412 and/or through the physical communication links 414 and processes the data in accordance with one or more sets of instructions stored in the memory 404b to output any of the values described herein.

Each of the processors 402a, 404a may include any suitable number of processors and/or processor types. For example, the processors 402a, 404a may each include one or more CPUs and one or more graphics processing units (GPUs). Generally, each of the processors 402a, 404a may be configured to execute software instructions stored in each of the corresponding memories 402b, 404b, which may each include one or more persistent memories (e.g., a hard drive and/or solid-state memory).

The networking interface 402c may enable the calibration processing device 402 to communicate with the control system 404 and/or any other connected devices or combinations thereof through the networking interface 404c. The networking interfaces 402c, 404c generally support one or more of the communication/network protocols implemented by the network 108. Moreover, the network 412 may be a single communication network, or may include multiple communication networks of one or more types (e.g., one or more wired and/or PANs or LANs, and/or one or more WANs such as the Internet). In some embodiments, the network 412 includes multiple, entirely distinct networks.

It will be understood that the above disclosure is one example and does not necessarily describe every possible embodiment. As such, it will be further understood that alternate embodiments may include fewer, alternate, and/or additional steps or elements.

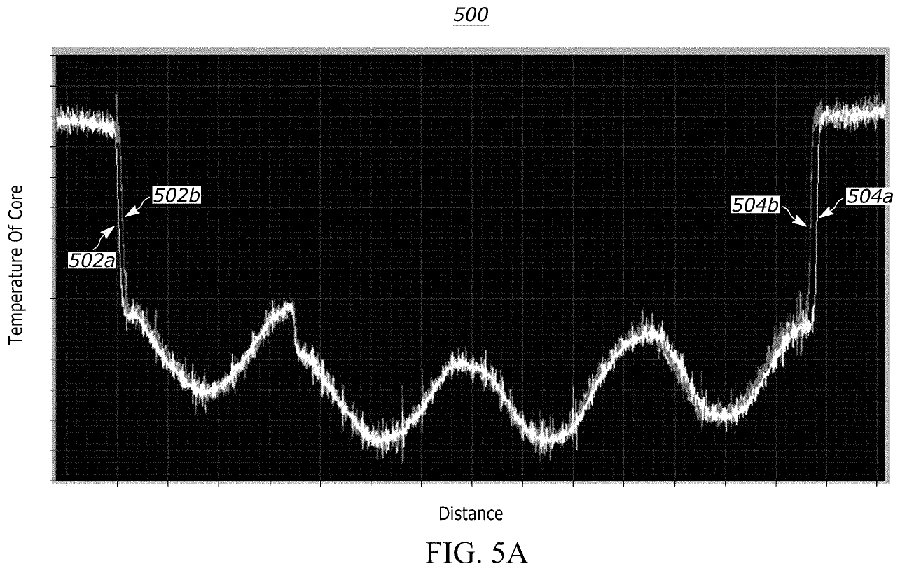

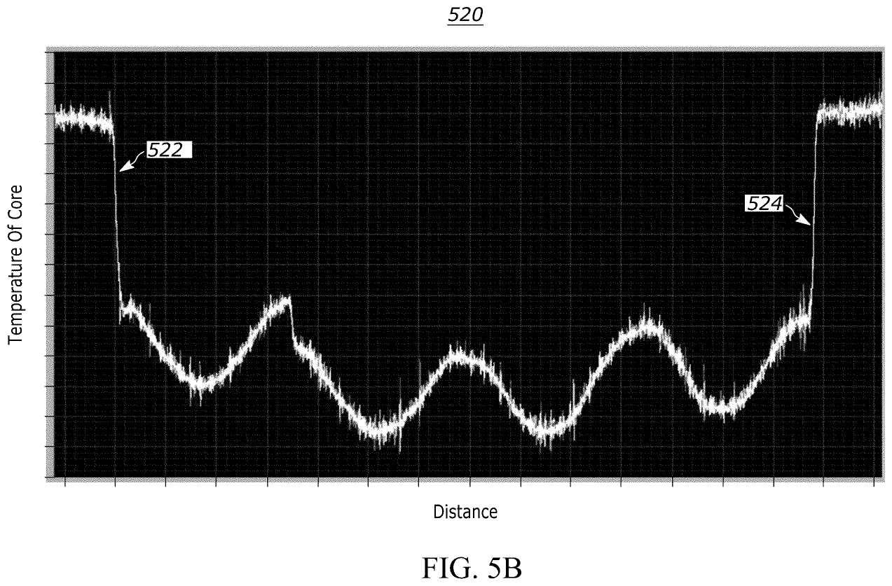

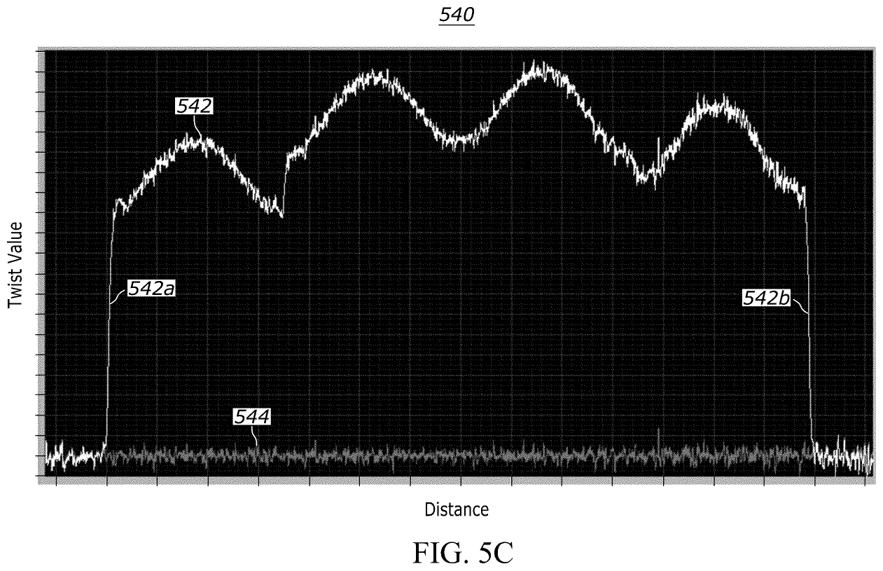

FIG. 5A is a plot 500 of a temperature response of multiple sensor cores of a fiber sensor over an affected region of the fiber sensor that includes a temperature response differential (in terms of position) between a first core and a second core, in accordance with various embodiments described herein. The plot 500 includes a first trace portion 502a and a second trace portion 504a of a first trace (e.g., of a first core) and a third trace portion 502b and a fourth trace portion 504b associated with a second trace (e.g., of a second core). More specifically, the first trace portion 502a is associated with the first core temperature response at a first temperature transition region (e.g., region 202a), the second trace portion 504a is associated with the first core temperature response at a second temperature transition region (e.g., region 202b), the third trace portion 502b is associated with a second core temperature response at the first temperature transition region, and the fourth trace portion 504b is associated with the second core temperature response at the second temperature transition region. While illustrated in FIG. 5A as traces (e.g., the first trace with portions 502a, 504a, and the second trace with portions 502b, 504b) associated with two cores, one or both of the traces may be aligned with one or more other traces that represent the temperature response of one or more other cores included as part of the fiber sensor.

For example, the second trace (e.g., with third/fourth portions 502b, 504b) may be comprised of five or six different traces that are nearly indistinguishable from one another, indicating that each of the corresponding five or six fiber cores had a nearly identical temperature response at the first temperature transition region. Further, in examples where the first trace (e.g., with first/second portions 502a, 504a) and/or the second trace are comprised of multiple, indistinguishable traces, each of the cores with temperature responses comprising the respective traces may be aligned, such that the optical path length parameter and the relative group index parameter determined as described herein may only align the cores with temperature responses comprising the first trace to cores with temperature responses comprising the second trace.

As illustrated in FIG. 5A, the affected region of the fiber sensor (e.g. extending from the first/third trace portions 502a, 502b to the second/fourth trace portions 504a, 504b) is relatively tightly confined, as the trace portions 502a, 502b, 504a, 504b represent a sharp temperature transition between the heated/cooled and ambient portions of the fiber sensor. In certain embodiments, the fiber sensor is largely comprised of glass and encased in plastic (e.g., cladding 104), which has thermal coefficients sufficient to prevent the significant spread of heat outside of the affected region. Nevertheless, the trace portions 502a, 502b, 504a, 504b indicate differentials in the temperature response between the first core (e.g., associated with first/second portions 502a, 504a) and the second core (e.g., associated with third/fourth portions 504a, 504b), and these differentials are utilized by the data processing circuitry described herein to determine an optical path length parameter and a relative group index parameter to compensate for these visible differences.

As mentioned, the plot 500 generally shows a fiber sensor temperature response for multiple cores as a function of position along the fiber (e.g., within the affected region). The imposed temperature difference changes the index of refraction of the individual cores, yielding a phase value that the data processing circuitry described herein may use to determine the optical path length parameter. In particular, the data processing circuitry evaluates the differences in position and/or other aspects of the temperature response between the trace portion 502a and the trace portion 502b to extract the various values (e.g., offsets, cross-correlations, etc.) included as part of the algorithms configured to determine the optical path length parameter and the relative group index parameter.

In certain embodiments, the data processing circuitry also analyzes apparent strain changes of the cores as a result of the temperature transitions represented by the various trace portions 502a, 502b, 504a, 504b to determine one or more of the various values previously described. Heating/cooling of the fiber sensor imposes a relatively small strain on the fiber sensor associated with thermal expansion of the cores. This strain imposes a relatively small phase change on the fiber sensor signals relative to the larger phase change associated with the change in index of refraction.

For example, the data processing circuitry may already have determined and/or otherwise have access to strain optic coefficients for each core that indicate the core's specific response to strain. The data processing circuitry can then leverage these strain optic coefficients with the phase changes in the temperature transition regions to determine one or more of the optical path length parameter and/or the relative group index parameter.

FIG. 5B is a plot 520 of a temperature response of multiple sensor cores of a fiber sensor over an affected region of the fiber sensor after application of an optical path length parameter and/or a relative group index parameter, in accordance with various embodiments described herein. The plot 520 includes a first aligned trace portion 522 and a second aligned trace portion 524 that are comprised of the first trace (e.g., of the first core) and the second trace (e.g., of the second core) illustrated in FIG. 5A. More specifically, the first aligned trace portion 522 is associated with the first core and second core temperature responses at the first temperature transition region from FIG. 5A, and the second aligned trace portion 524 is associated with the first core and the second core temperature responses at the second temperature transition region from FIG. 5A.

While illustrated/described in FIG. 5B as an aligned trace associated with two cores, the aligned trace may be aligned with one or more other traces that represent the temperature response of one or more other cores included as part of the fiber sensor. For example, the aligned trace may be comprised of five, six, or seven different traces that are nearly indistinguishable from one another, indicating that each of the corresponding five to seven fiber cores had a nearly identical temperature response at the first temperature transition region and the second temperature transition region. Thus, when applied to the data received from the individual cores, the optical path length parameter and the relative group index parameter resolve the positional differences in the temperature response of the multiple cores.

FIG. 5C is a plot 540 indicating a twist value of a fiber sensor before and after optimizing parameters of a first core of the fiber sensor based on interferometric pattern data resulting from temperature transition regions over an affected region of the fiber sensor, in accordance with various embodiments described herein. The plot 540 includes a first trace 542 representing the twist calculated for a first core prior to applying the optical path length parameter and the relative group index parameter to the data received from the first core, and a second trace 544 representing the twist calculation following application of the optical path length parameter and the relative group index parameter to the data received from the first core. The first trace includes a first portion 542a representing the twist calculated based on the imposed temperature transition across the affected region of the fiber sensor at a first temperature transition region (e.g., region 202a) and a second portion 542b representing the twist calculated based on the imposed temperature transition across the affected region of the fiber sensor at a second temperature transition region (e.g., region 202b).

The data processing circuitry receives the twist data represented by the first trace 542 and analyzes how straight the twist values are at the transition points of the first and second portions 542a, 542b. In particular, the data processing circuitry calculates the twist of the signal from the first core represented by the first trace 542 and drives the inflection points of the first and second portions 542a, 542b to be as straight as possible by adjusting the optical path length parameter and the relative group index parameter until the first trace 542 approximates the second trace 544.

Generally, the data processing circuitry uses phase derivative signals (e.g., related to strain) for multiple cores to calculate the twist. For example, the data processing circuitry may utilize phase derivative signals from three outer cores (e.g., cores 102b-g) and a center core (e.g., center core 102a). The data processing circuitry filters these phase derivative signals and compares the average strain of the three outer cores with the strain of the center core to determine the amount of strain that is not accounted for by bend or actual strain, which the circuitry then uses to determine the amount of twist. For a theoretical fiber sensor with ideal core geometry and uniform relative strain optic coefficients for all cores, the data processing circuitry would calculate the twist as a function of, or otherwise based on:

$$3 C - ( I + J + K ) , \qquad ( 1 )$$

where C represents the phase change occurring in the center core, and I, J, and K represent the respective phase changes occurring in each of the outer cores (e.g., at 0°, 120°, and 240° rotationally around the center core, respectively). Equation (1) provides an accurate twist measurement because the C, I, J, and K cores all experience the same axial strain, and bend is excluded because the rotational locations of I, J, and K will create sinusoids that are 120° out of phase with each other.

Additionally, or alternatively, the data processing circuitry can calculate the twist values based on a center core and one or more outer cores. For example, the data processing circuitry can calculate the twist as a function of, or otherwise based on any of:

$$C - I , \qquad ( 2 )$$

$$C - J , \qquad ( 3 )$$

$$C - K , \qquad ( 4 )$$

$$2 C - ( I + J ) , \qquad ( 5 )$$

$$2 C - ( I + K ) , \qquad ( 6 )$$

$$2 C - ( J + K ) , \qquad ( 7 )$$

and these twist calculations may be generalized to any N number of outer cores, where Nis any positive integer value.

However, for real fiber sensors, the data processing circuitry generally calculates coefficients (including twist) by inverting the following matrix:

Matrix 1

| | | | |
|---|---|---|---|
| r_{c} sin (θ_{c}) | r_{c} cos (θ_{c}) | r_{c}² | RSO_{c} |
| rᵢ sin (θᵢ) | rᵢ cos (θᵢ) | rᵢ² | RSOᵢ |
| rⱼ sin (θⱼ) | rⱼ cos (θⱼ) | rⱼ² | RSOⱼ |
| rₖ sin (θₖ) | rₖ cos (θₖ) | rₖ² | RSOₖ |

where r and θ are the relative core geometry, with r representing a relative distance of each outer core from the center core and θ representing the angle starting with a first outer core (e.g., outer core 102b) positioned at 0° rotationally around the center core, RSO is a relative strain optic coefficient representing the response each respective core has to strain (e.g., axial strain). When the data processing circuitry inverts Matrix 1, the bend x coefficients are represented by the values in the first row, the bend y coefficients are represented by the values in the second row, the twist coefficients are represented by the values in the third row, and the strain coefficients are represented by the values in the fourth row.

Regardless, the data processing circuitry can calculate the necessary twist values for the fiber sensor and may iteratively do so until adjustments to the optical path length parameter and the relative group index parameter, when applied to the data (e.g., temperature data) from the first core, results in a calculated twist trace that resembles the second trace 544 (e.g., zero twist across the affected region).

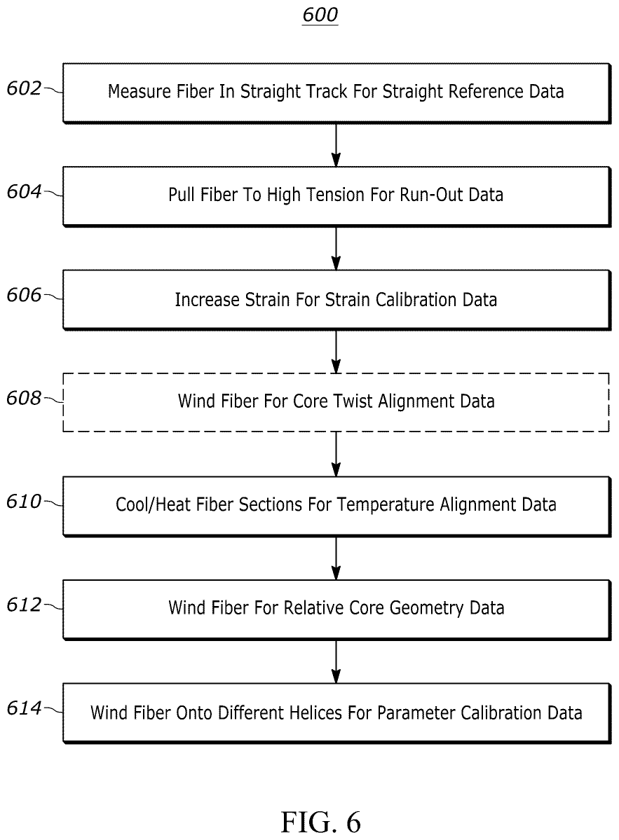

FIG. 6 depicts a flow diagram representing an example computer-implemented method 600 for calibrating a fiber sensor, in accordance with various embodiments described herein. Generally, the method 600 may be implemented by one or more processors of the example calibration system 400, such as the one or more processors 402a of the calibration processing device 402 (e.g., executing the calibration coefficient instructions 402b1), for example.

The method 600 includes measuring a fiber sensor in a straight track for straight reference data (block 602). As previously mentioned, manufacturing imperfections can lead to several defects in the fiber sensor that deviate from the target/ideal configuration, such that the straight reference data acts as a baseline to compare against subsequent calibration actions/calculations. For example, even when the fiber sensor is under no applied strain and is laid straight, the fiber sensor may be in a very slight spiral.

The method 600 further includes pulling the fiber sensor to high tension to determine run-out data (block 604). Run-out generally references the fact that fiber sensors can be slightly off-axis when spun during manufacturing, so when the fiber sensor is under no strain, the fiber sensor remains in a very slight spiral even when laid straight. The control systems receive data of the fiber sensor in the high-tension state and calculate a correction to the straight reference data that accounts for run-out, thereby further straightening the straight reference data.

The method 600 further includes increasing the strain on the fiber sensor and taking data to calculate strain optic coefficients for each fiber sensor core (block 606). Generally, each core of a multi-core fiber sensor may experience slightly different phase changes with any change in strain. The data processing circuitry described herein may calibrate the strain optic coefficients for each core of the fiber sensor based on these strain response differences between/among the various cores of the fiber sensor.

The method 600 optionally includes winding the fiber sensor to acquire twist data (optional block 608). The control systems described herein may control twisting of the fiber sensor onto a cylindrical barrel and take data form each of the outer cores to determine the relative misalignment between/among the various outer cores. As previously mentioned, any misalignment in the outer cores may generally appear in the twist signal data as a sinusoidal waveform with a frequency approximately equal to the spin rate of the fiber sensor (e.g., as governed by the spin rate of the cylindrical barrel). Optional block 608 may further include optimizing the outer core alignment by minimizing the amplitude of the sinusoid appearing within the twist measurement data.

The method 600 further includes cooling/heating the fiber sensor to acquire temperature alignment data (block 610). Block 610 generally includes pulling the fiber sensor to high strain, cooling the fiber sensor (e.g., one or more portions of the fiber sensor), acquiring temperature data while cooled, heating one or more portions of the fiber sensor, and acquiring temperature data while heated. Block 610 further includes calibrating the relative temperature coefficients using these two data sets (e.g., cooled and heated), and using the data sets to determine the optical path length parameter and the relative group index parameter, as described herein. It should be noted that determining the optical path length parameter and the relative group index parameter may enable the data processing circuitry of the systems described herein to align the outer cores of a multi-core fiber sensor, and thereby improve or reduce the system's reliance on the actions performed at block 608.

Generally, the relative thermo-optic (i.e., temperature) coefficients account for the fact that each core experiences phase changes at a different rate with varying temperature than the other cores. The data processing circuitry described herein may use data from the two temperature data sets (e.g., heating and cooling) to calculate the relative temperature coefficients by dividing the phase change for any outer core by the phase change of the center core. Block 610 may further include correcting the twist for temperature, by adding a column to Matrix 1 that includes the relative temperature coefficients and a row for an additional outer core that generates data that is used for temperature compensation.

The method 600 further includes winding the fiber sensor (e.g., onto a cylindrical barrel) to acquire data for determining the core geometry of the fiber sensor (block 612). The core geometry generally indicates the positions of the outer cores, which includes the relative distance of each outer core from the center core and the rotational angle of each outer core relative to the center core.

The method 600 further includes winding the fiber sensor onto one or more different sized helices (e.g., cylindrical barrels) to acquire data for other parametric calibrations (block 614). Block 614 may include acquiring data from the fiber sensor at multiple different strains and twists to calibrate a number of other parameters, such as twist gain, distributed bend gain, twist scale factor, and the like. For example, errors in these various parameters can cause the pitch of the helix threads to be measured incorrectly, which provides a direct path to optimize the parameters by minimizing the error in the helix thread pitch.

Of course, it is to be appreciated that the actions of the method 600 may be performed any suitable number of times, and the order of the method 600 may vary, such that any of blocks 606-612 may be performed in any suitable order. Further, the method 600 may include additional steps or actions, in certain embodiments. For example, the method 600 may further include a calibration check process following the calibration represented by the method 600. This calibration check process may include determining, with the data processing circuitry, a phase value associated with one or more cores of the fiber sensor based on the optical path length parameter and the relative group index parameter; and calculating, with the data processing circuitry, a shape value corresponding to a shape of the fiber sensor based on the phase value.

In certain embodiments, the method 600 may further include producing, with the data processing circuitry, compensated interferometric pattern data by applying the optical path length parameter and the relative group index parameter to the interferometric pattern data or to further interferometric pattern data. The further interferometric pattern data may span at least the affected region for each core of a first core and a second core of the fiber sensor. The method 600 may further includes determining, with the data processing circuitry, a shape parameter of the fiber sensor using the compensated interferometric pattern data, and the shape parameter may comprise a parameter selected from the group consisting of: a bend parameter, a twist parameter, and a strain parameter. The method 600 may further include providing signals indicative of the shape parameter.

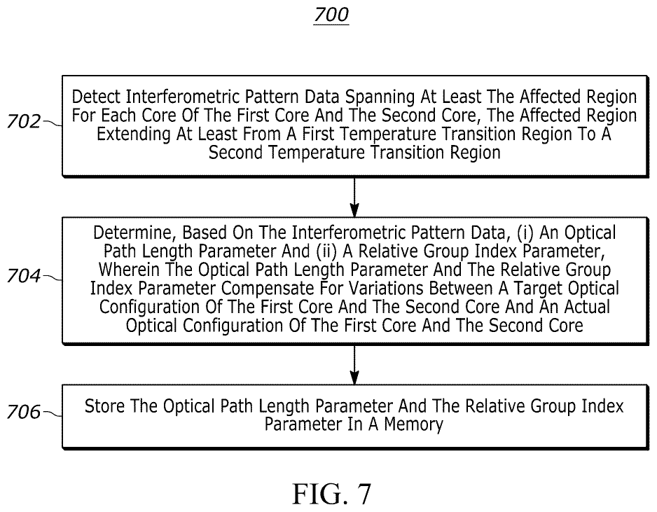

FIG. 7 depicts a flow diagram representing another example computer-implemented method 700 for determining compensation parameters based on interferometric pattern data resulting from temperature transitions over an affected region of a fiber sensor, in accordance with various embodiments described herein. The method 700 may be implemented by one or more processors of the example calibration system 400, such as the one or more processors 402a of the calibration processing device 402 (e.g., executing the calibration coefficient instructions 402b1), for example.

The method 700 includes detecting, with an interferometric detection circuitry when the fiber sensor is experiencing temperature transitions over an affected region, interferometric pattern data spanning at least the affected region for each core of the first core and the second core, the affected region extending at least from a first temperature transition region to a second temperature transition region (block 702). The method 700 further includes determining, with a data processing circuitry and based on the interferometric pattern data, (i) an optical path length parameter and (ii) a relative group index parameter that compensate for variations between a target optical configuration of the first core and the second core and an actual optical configuration of the first core and the second core (block 704). The method 700 further includes storing the optical path length parameter and the relative group index parameter in a memory (block 706).

In certain embodiments, the method 700 further includes applying, with a heating or cooling apparatus, temperature transitions to the fiber sensor to produce the first temperature transition region and the second temperature transition region.

In some embodiments, determining the optical path length parameter and the relative group index parameter includes determining, based on the interferometric pattern data, a first twist parameter at the first temperature transition region and a second twist parameter at the second temperature transition region, wherein the first twist parameter indicates deviations from the target optical configuration of the first core and the second core at the first temperature transition region, and wherein the second twist parameter indicates deviations from the target optical configuration of the first core and the second core at the second temperature transition region.

In certain embodiments, the method 700 further includes determining, by the data processing circuitry, a first offset value based on a first linear fit of the first twist parameter across the first temperature transition region and a second offset value based on a second linear fit of the second twist parameter across the second temperature transition region, wherein the first offset is between the interferometric pattern data of the first and second cores at the first temperature transition region, wherein the second offset is between the interferometric pattern data of the first and second cores at the second temperature transition region, wherein the first core is a center core, and wherein the second core is an outer core spun around the center core; and determining, by the data processing circuitry, the optical path length parameter and the relative group index parameter based on a linear fit of the first offset value and the second offset value.

In some embodiments, determining the optical path length parameter and the relative group index parameter includes determining, by the data processing circuitry, a first cross-correlation between phases of the interferometric pattern data of the first core and the second core at the first temperature transition region, and a second cross-correlation between phases of the interferometric pattern data of the first core and the second core at and the second temperature transition region; and determining, from the first cross-correlation and the second cross-correlation, the optical path length parameter and the relative group index parameter.

In certain embodiments, the fiber sensor further includes at least one additional core, and the second core and the at least one additional core form a plurality of cores. In these embodiments, the method 700 further includes detecting, with the interferometric detection circuitry when the fiber sensor is experiencing the temperature transitions over the affected region, interferometric pattern data spanning at least the affected region for the at least one additional core. Further in these embodiments, the first cross-correlation is between a phase of the interferometric pattern data of the first core and an average phase of the interferometric pattern data of the plurality of cores at the first temperature transition region; and the second cross-correlation is between a phase of the interferometric pattern data of the first core and an average phase of the interferometric pattern data of the plurality of cores at the second temperature transition region.

In some embodiments, determining the optical path length parameter and the relative group index parameter includes determining a first relative phase offset between the interferometric pattern data of the first core and the second core at a first location in the first temperature transition region, and a second relative phase offset between the interferometric pattern data of the first core and the second core at a second location in the second temperature transition region; and determining the optical path length parameter and the relative group index parameter based on the first relative phase offset and the second relative phase offset.

In certain embodiments, the fiber sensor includes at least one additional core, and the second core and the at least one additional core form a plurality of cores. In these embodiments, the method 700 further includes detecting, with the interferometric detection circuitry when the fiber sensor is experiencing the temperature transitions over the affected region, interferometric pattern data spanning at least the affected region for the at least one additional core. Further in these embodiments, the first relative phase offset is between a phase of the interferometric pattern data of the first core and an average phase of the interferometric pattern data of the plurality of cores at the first temperature transition region; and the second relative phase offset is between a phase of the interferometric pattern data of the first core and an average phase of the interferometric pattern data of the plurality of cores at the second temperature transition region.

In some embodiments, the method 700 further includes determining, with the data processing circuitry, a phase value associated with one or more cores based on the optical path length parameter and the relative group index parameter, the one or more cores comprising a core selected from the group consisting of: the first core and the second core; and calculating, with the data processing circuitry, a shape value corresponding to a shape of the fiber sensor based on the phase value.

In certain embodiments, the interferometric pattern data spanning at least an affected region for each of a first core and a second core is first interferometric pattern data, and the fiber sensor further comprises at least one additional core. The second core and the at least one additional core may form a plurality of cores spun around the first core (e.g., a center core). In these embodiments, the method 700 further includes detecting, at a different time than when the first interferometric pattern data is detected, second interferometric data for each core of the plurality of cores; and determining, with the data processing circuitry and based on second interferometric pattern, an additional optical path length parameter and an additional relative group index parameter. The additional optical path length parameter and the additional relative group index parameter may compensate for variations between a target optical configuration of the plurality of cores and an actual optical configuration of the plurality of cores.

In certain embodiments, the fiber sensor includes at least one additional core, and the second core and the at least one additional core form a plurality of cores. In these embodiments, the method 700 further includes detecting, with the interferometric detection circuitry when the fiber sensor is experiencing the temperature transitions over the affected region, interferometric pattern data spanning at least the affected region for the at least one additional core, and determining, with the data processing circuitry, additional optical path length parameters and additional relative group index parameters that compensate for variations between a target optical configuration of the plurality of cores and an actual optical configuration of the plurality of cores. Further in these embodiments, the additional optical path length parameters and the additional relative group index parameters compensate for variations between the target optical configuration of the first core relative to the plurality of cores and an actual optical configuration of the first core relative to the plurality of cores.

Of course, it is to be appreciated that the actions of the method 700 may be performed any suitable number of times, and that the actions described in reference to the method 700 may be performed in any suitable order.

One or more components of the embodiments discussed in this disclosure may be implemented in software for execution on one or more processors of a computer system. The software may include code that when executed by the one or more processors, configures the one or more processors to perform various functionalities as discussed herein. The code may be stored in a non-transitory computer-readable storage medium (e.g., a memory, magnetic storage, optical storage, solid-state storage, etc.). The computer-readable storage medium may be part of a computer readable storage device, such as an electronic circuit, a semiconductor device, a semiconductor memory device, a read only memory (ROM), a flash memory, an erasable programmable read only memory (EPROM); a floppy diskette, a CD-ROM, an optical disk, a hard disk, or other storage device. The code may be downloaded via computer networks such as the Internet, Intranet, etc. for storage on the computer-readable storage medium. The code may be executed by any of a wide variety of centralized or distributed data processing architectures. The programmed instructions of the code may be implemented as a number of separate programs or subroutines, or they may be integrated into a number of other aspects of the systems described herein. The components of the computing systems discussed herein may be connected using wired and/or wireless connections. In some examples, the wireless connections may use wireless communication protocols such as Bluetooth, near-field communication (NFC), Infrared Data Association (IrDA), home radio frequency (HomeRF), IEEE 802.11, Digital Enhanced Cordless Telecommunications (DECT), and wireless medical telemetry service (WMTS).

Various general-purpose computer systems may be used to perform one or more processes, methods, or functionalities described herein. Additionally or alternatively, various specialized computer systems may be used to perform one or more processes, methods, or functionalities described herein. In addition, a variety of programming languages may be used to implement one or more of the processes, methods, or functionalities described herein.

While certain embodiments and examples have been described above and shown in the accompanying drawings, it is to be understood that such embodiments and examples are merely illustrative and are not limited to the specific constructions and arrangements shown and described, since various other alternatives, modifications, and equivalents will be appreciated by those with ordinary skill in the art.

What is claimed is:

1. A method of determining compensation parameters for a fiber sensor including a first core and a second core, the method comprising:
detecting, with an interferometric detection circuitry when the fiber sensor is experiencing temperature transitions over an affected region, interferometric pattern data spanning at least the affected region for each core of the first core and the second core, the affected region extending at least from a first temperature transition region to a second temperature transition region;
determining, with a data processing circuitry and based on the interferometric pattern data, (i) an optical path length parameter and (ii) a relative group index parameter, wherein the optical path length parameter and the relative group index parameter compensate for variations between a target optical configuration of the first core and the second core and an actual optical configuration of the first core and the second core; and
storing the optical path length parameter and the relative group index parameter in a memory.

2. The method of claim 1, further comprising:
applying, with a heating or cooling apparatus, different temperatures to the fiber sensor;
detecting, with the interferometric detection circuitry, interferometric pattern data for each core of the first core and the second core while the heating or cooling apparatus is applying different temperatures to the fiber sensor;
determining, with the data processing circuitry and based on the interferometric pattern data, a temperature parameter that compensates for variations in temperature response between the first and second cores; and
storing the temperature parameter in the memory.

3. The method of claim 1, wherein determining the optical path length parameter and the relative group index parameter comprises:
determining, based on the interferometric pattern data, a first twist parameter at the first temperature transition region and a second twist parameter at the second temperature transition region, wherein the first twist parameter indicates deviations from the target optical configuration of the first core and the second core at the first temperature transition region, and wherein the second twist parameter indicates deviations from the target optical configuration of the first core and the second core at the second temperature transition region.

4. The method of claim 3, further comprising:
determining, by the data processing circuitry, a first offset value based on a first linear fit of the first twist parameter across the first temperature transition region and a second offset value based on a second linear fit of the second twist parameter across the second temperature transition region, wherein a first offset associated with the first offset value is between the interferometric pattern data of the first and second cores at the first temperature transition region, wherein a second offset associated with the second offset value is between the interferometric pattern data of the first and second cores at the second temperature transition region, wherein the first core is a center core, and wherein the second core is an outer core spun around the center core; and
determining, by the data processing circuitry, the optical path length parameter and the relative group index parameter based on a linear fit of the first offset value and the second offset value.

5. The method of claim 1, wherein determining the optical path length parameter and the relative group index parameter comprises:
determining, by the data processing circuitry, a first cross-correlation between phases of the interferometric pattern data of the first core and the second core at the first temperature transition region, and a second cross-correlation between phases of the interferometric pattern data of the first core and the second core at and the second temperature transition region; and
determining, from the first cross-correlation and the second cross-correlation, the optical path length parameter and the relative group index parameter.

6. The method of claim 5, wherein:
the fiber sensor further comprises at least one additional core;
the second core and the at least one additional core form a plurality of cores;
the method further comprises: detecting, with the interferometric detection circuitry when the fiber sensor is experiencing the temperature transitions over the affected region, interferometric pattern data spanning at least the affected region for the at least one additional core;
the first cross-correlation is between a phase of the interferometric pattern data of the first core and an average phase of the interferometric pattern data of the plurality of cores at the first temperature transition region; and
the second cross-correlation is between a phase of the interferometric pattern data of the first core and an average phase of the interferometric pattern data of the plurality of cores at the second temperature transition region.

7. The method of claim 1, wherein determining the optical path length parameter and the relative group index parameter comprises:
determining a first relative phase offset between the interferometric pattern data of the first core and the second core at a first location in the first temperature transition region, and a second relative phase offset between the interferometric pattern data of the first core and the second core at a second location in the second temperature transition region; and
determining the optical path length parameter and the relative group index parameter based on the first relative phase offset and the second relative phase offset.

8. The method of claim 7, wherein:
the fiber sensor further comprises at least one additional core;
the second core and the at least one additional core form a plurality of cores;
the method further comprises: detecting, with the interferometric detection circuitry when the fiber sensor is experiencing the temperature transitions over the affected region, interferometric pattern data spanning at least the affected region for the at least one additional core;
the first relative phase offset is between a phase of the interferometric pattern data of the first core and an average phase of the interferometric pattern data of the plurality of cores at the first temperature transition region; and
the second relative phase offset is between a phase of the interferometric pattern data of the first core and an average phase of the interferometric pattern data of the plurality of cores at the second temperature transition region.

9. An apparatus for determining compensation parameters for a fiber sensor including a first core and a second core, the apparatus comprising:
interferometric detection circuitry configured to detect, when the fiber sensor is experiencing temperature transitions over an affected region, interferometric pattern data spanning at least the affected region for each core of the first core and the second core, the affected region extending at least from a first temperature transition region to a second temperature transition region; and
data processing circuitry configured to:
determine, based on the interferometric pattern data, (i) an optical path length parameter and (ii) a relative group index parameter, wherein the optical path length parameter and the relative group index parameter compensate for variations between a target optical configuration of the first core and the second core and an actual optical configuration of the first core and the second core; and
store the optical path length parameter and the relative group index parameter in a memory.

10. The apparatus of claim 9, further comprising: a heating or cooling apparatus configured to apply temperature transitions to the fiber sensor to produce the first temperature transition region and the second temperature transition region.

11. The apparatus of claim 10, wherein the apparatus further comprises:
the heating or cooling apparatus is further configured to apply different temperatures to the fiber sensor; wherein:
the interferometric detection circuitry is further configured to: detect interferometric pattern data for each core of the first core and the second core while the heating or cooling apparatus is applying different temperatures to the fiber sensor; and
the data processing circuitry is further configured to:
determine, with the data processing circuitry and based on the interferometric pattern data, a temperature parameter that compensates for variations in temperature response between the first and second cores; and
store the temperature parameter in the memory.

12. The apparatus of claim 9, wherein the data processing circuitry is further configured to determine the optical path length parameter and the relative group index parameter by:
determining, based on the interferometric pattern data, a first twist parameter at the first temperature transition region and a second twist parameter at the second temperature transition region, wherein the first twist parameter indicates deviations from the target optical configuration of the first core and the second core at the first temperature transition region, and wherein the second twist parameter indicates deviations from the target optical configuration of the first core and the second core at the second temperature transition region.

13. The apparatus of claim 12, wherein the data processing circuitry is further configured to:
determine a first offset value based on a first linear fit of the first twist parameter across the first temperature transition region and a second offset value based on a second linear fit of the second twist parameter across the second temperature transition region, wherein a first offset associated with the first offset value is between the interferometric pattern data of the first and second cores at the first temperature transition region, wherein a second offset associated with the second offset value is between the interferometric pattern data of the first and second cores at the second temperature transition region, wherein the first core is a center core, and wherein he second core is an outer core spun around the center core; and
determine the optical path length parameter and the relative group index parameter based on a linear fit of the first offset value and the second offset value.

14. The apparatus of claim 9, wherein the data processing circuitry is further configured to determine the optical path length parameter and the relative group index parameter by:
determining a first cross-correlation between phases of the interferometric pattern data of the first core and the second core at the first temperature transition region, and a second cross-correlation between phases of the interferometric pattern data of the first core and the second core at and the second temperature transition region; and
determining, from the first cross-correlation and the second cross-correlation, the optical path length parameter and the relative group index parameter.

15. The apparatus of claim 14, wherein:
the fiber sensor further comprises at least one additional core;
the second core and the at least one additional core form a plurality of cores;
the interferometric detection circuitry is further configured to: detect, when the fiber sensor is experiencing the temperature transitions over the affected region, interferometric pattern data spanning at least the affected region for the at least one additional core;
the first cross-correlation is between a phase of the interferometric pattern data of the first core and an average phase of the interferometric pattern data of the plurality of cores at the first temperature transition region; and
the second cross-correlation is between a phase of the interferometric pattern data of the first core and an average phase of the interferometric pattern data of the plurality of cores at the second temperature transition region.

16. The apparatus of claim 9, wherein the data processing circuitry is further configured to determine the optical path length parameter and the relative group index parameter by:
determining a first relative phase offset between the interferometric pattern data of the first core and the second core at a first location in the first temperature transition region, and a second relative phase offset between the interferometric pattern data of the first core and the second core at a second location in the second temperature transition region; and
determining the optical path length parameter and the relative group index parameter based on the first relative phase offset and the second relative phase offset.

17. The apparatus of claim 16, wherein:
the fiber sensor further comprises at least one additional core;
the second core and the at least one additional core form a plurality of cores;
the interferometric detection circuitry is further configured to: detect, when the fiber sensor is experiencing the temperature transitions over the affected region, interferometric pattern data spanning at least the affected region for the at least one additional core;
the first relative phase offset is between a phase of the interferometric pattern data of the first core and an average phase of the interferometric pattern data of the plurality of cores at the first temperature transition region; and
the second relative phase offset is between a phase of the interferometric pattern data of the first core and an average phase of the interferometric pattern data of the plurality of cores at the second temperature transition region.

18. The apparatus of claim 9, wherein the data processing circuitry is further configured to:
determine a phase value associated with one or more cores based on the optical path length parameter and the relative group index parameter, the one or more cores comprising a core selected from the group consisting of: the first core and the second core; and
calculate a shape value corresponding to a shape of the fiber sensor based on the phase value.

19. The apparatus of claim 9, wherein:
the interferometric pattern data spanning at least the affected region for each core of the first core and the second core is first interferometric pattern data;
the fiber sensor further comprises at least one additional core;
the second core and the at least one additional core form a plurality of cores spun around the first core; and
the data processing circuitry is further configured to:
detect, at a different time than when the first interferometric pattern data is detected, second interferometric data for each core of the plurality of cores; and
determine, with the data processing circuitry and based on second interferometric pattern, an additional optical path length parameter and an additional relative group index parameter, wherein the additional optical path length parameter and the additional relative group index parameter compensate for variations between a target optical configuration of the plurality of cores and an actual optical configuration of the plurality of cores.

20. The apparatus of claim 9, wherein:
the fiber sensor further comprises at least one additional core;
the second core and the at least one additional core form a plurality of cores;
the interferometric detection circuitry is further configured to detect, when the fiber sensor is experiencing the temperature transitions over the affected region, interferometric pattern data spanning at least the affected region for the at least one additional core;
the data processing circuitry is further configured to determine additional optical path length parameters and additional relative group index parameters that compensate for variations between a target optical configuration of the plurality of cores and an actual optical configuration of the plurality of cores; and
the additional optical path length parameters and the additional relative group index parameters compensate for variations between the target optical configuration of the first core relative to the plurality of cores and an actual optical configuration of the first core relative to the plurality of cores.

21. The apparatus of claim 9, wherein:
the first core and the second core are disposed a single cladding; or
the first core and the second core comprise cores of a plurality of single-core fibers.

22. The apparatus of claim 9, wherein the second core is spun around the first core.

23. A non-transitory computer-readable medium storing instructions for determining compensation parameters for a fiber sensor that, when executed, cause one or more processors of a control system to perform a method comprising:
detecting, with an interferometric detection circuitry when the fiber sensor is experiencing temperature transitions over an affected region, interferometric pattern data spanning at least the affected region for each core of a first core and a second core, the affected region extending at least from a first temperature transition region to a second temperature transition region;
determining, with a data processing circuitry and based on the interferometric pattern data, (i) an optical path length parameter and (ii) a relative group index parameter, wherein the optical path length parameter and the relative group index parameter compensate for variations between a target optical configuration of the first core and the second core and an actual optical configuration of the first core and the second core; and
storing the optical path length parameter and the relative group index parameter in a memory.
